(19) United States
(12) Patent Application Publication
(10) Pub. No.: US 2023/0102287 A1
(43) Pub. Date: Mar. 30, 2023

(54) VOLKOV CAVITATIONAL AERATOR

(71) Applicant: Andrei Leonidovich Volkov, Yaroslavi (RU)

(72) Inventor: Andrei Leonidovich Volkov, Yaroslavl (RU)

(21) Appl. No.: 17/907,008

(22) PCT Filed: Nov. 23, 2020
(86) PCT No.: PCT/RU2020/000628

§ 371 Date: Sep. 22, 2022

(30) Foreign Application Priority Data
Mar. 23, 2020 (RU) RU2020111880

(51) Int. Cl. B01F 23/237; B01F 23/232

(52) U.S. Cl. CPC B01F 23/237611; B01F 23/232

(57) ABSTRACT

Proposed is a device for aerating a liquid. The device includes a housing having a liquid inlet channel, an air inlet channel and an outlet channel for a mixture of liquid and air. Mounted in the housing is a conical nozzle containing a swirler for feeding in liquid under pressure, the swirler having helical grooves on its outer surface. Mounted in the region where a conical jet of liquid exits an opening in the conical portion of the nozzle is a baffle with which the flow of liquid collides, resulting in cavitation, wherein air enters into the inner region of the jet of liquid via a channel in the baffle and through an opening in the baffle.

### CROSS REFERENCE TO RELATED APPLICATION

This application is a national stage entry of PCT/RU2020/000628 filed Nov. 23, 2020, under the International Convention claiming priority over Russian Patent Application No. RU2020111880 filed Mar. 23, 2020.

### FIELD OF TECHNOLOGY

The claimed invention relates to the field of mixing equipment for saturation in various technologies using gas-liquid systems via active aeration by the gaseous phase, in particular by oxygen, of various liquids, in particular water, with the effect of accelerating diffusion—kinetic processes during physical mass transfer involving chemical reactions behavior in phases due to cavitation phenomena.

### STATE OF THE ART

A device is known—an aerator Patent of the Russian Federation No 2292233, designed for forced supply and dispersion of air or oxygen to various devices. It comprises an air supply pipe with elastic dispersants made of rubber.

The complaint of this aerator is that its operation is based on dispersion of the gas phase into a liquid with an active gas phase. The interfacial surface determining the saturation efficiency is insignificant in this case and is determined by the total surface of the bubbles formed during dispersion, whereas increase of the air pressure in the pipe due to the hydrodynamic stability of the dispersants, their fluctuations will be minimized, which will further reduce the gas content of the liquid phase and decrease the interfacial surface.

The aerator Patent of the Russian Federation No 2231499 is known with a dispersing element made of a polymer material with different porosity varying along the cross-section profile of the shell element. In the course of the aerator operation the diameter of the formed bubbles varies—in the central part it is the largest whilst decreasing to the periphery. The complaint of this device is the increased hydraulic resistance to the passage of the gas medium through the shell. Uneven porosity results in different resistance for the gas medium over the shell surface area and in different gas throughput, which is the reason for increase in the number of large-diameter bubbles, as well as reduction of the interfacial surface area. The phenomenon of bubbles coalescence caused by the capture of the small bubbles by the large ones leads to a decrease in the area of the active contact surface of phases which in its turn reduces the efficiency of mass transfer.

The aerator Patent of the Russian Federation No 2645141 for supplying air to an aeration pool is known comprising an all-ceramic hollow body with walls of pressed single-fraction ceramic powder with a central hole and screw thread in the body, an incoming fitting which supplies air from the pipeline. The housing has one or more vertical cylindrical holes with impermeable walls and screw thread. The complaint of this aerator is its rather complex manufacturing technology, low aeration activity, high hydraulic resistance of air and insufficient mass transfer surface due to the fact that the active medium of its generation is air.

### SUMMARY OF THE INVENTION

The technical result of the proposed device is that the use of a hollow cone spray nozzle in an aerator, with a swirler located inside it, and a baffle, enables it to create an optimal mode of mixing water with air.

This is achieved by the fact that the improvement of the quality of mixing is ensured by formation of the water cone with the spiral movement of the liquid flow, generation of cavitation phenomenon due to shearing currents in the flow and a speed jump in the zone of the water jets collision with the baffle, where an area of low pressure is formed with the formation of vapor bubbles, their collapse; as well as air entrailling through the hole in the baffle, which is vigorously mixing with water. When bubbles collapse, there takes place a local rise in pressure and temperature, which increases the kinetic coefficients as well as the rate of diffusion and chemical processes. The mass transfer surface in this case will be determined by the surface area of the formed liquid droplets, the number of which in this device is vastly larger as opposed to the case when the active phase is a gaseous medium.

### BRIEF DESCRIPTION OF THE DRAWING

The essence of the proposed invention is explained by the attached drawing.

FIG. 1 shows a schematic diagram of the proposed device. The aerator comprising a housing 1, with a nozzle 2, which is essentially a hollow cone with a swirler 3, with a screw thread of flow passages 4 on its outer surface, the baffer 5, located opposite the opening of the tapered part of the nozzle, with a channel 6 for air suction, a water supply channel 7 and a water-air mixture outlet channel 8.

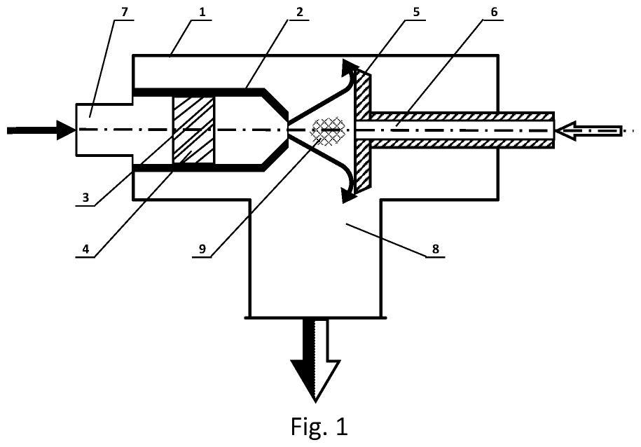

### DETAILED DESCRIPTION OF THE INVENTION

The device works as follows. Water or other liquid medium from a source (borehole or city water supply) is supplied under pressure to the aerator 1 to the nozzle and, while traveling through the channels of the swirler, acquires a kinematic helical movement. When exiting through the hole of the tapered part of the nozzle, it forms a hollow conical jet of water with a spiral movement of water particles relative to the aerator body. In the inner zone of the said water jet 9, due to the cavitation effect generated in the zone of water jets impact against the baffle, a zone of reduced pressure is formed. The air is sucked into it through channel 6 in the baffle, which, reaching the inner zone of the hollow conical jet of water, is captured by water and is vigorously mixed with it, which several-fold enhances the effect of, for instance, oxygen saturation of water. Then the gas-air mixture is directed through channel 8 to the separator for water degassing.

1. A device for aeration of a liquid comprising:
a housing with a liquid supply channel,
an air supply channel and a channel for removing a mixture of liquid and air,
wherein the liquid is supplied under pressure to a hollow-cone nozzle installed in the housing with a swirler located inside it and having screw-cut channels on an outer surface,
wherein in an exit zone of the conical liquid flow plume from the opening of the conical part of the nozzle, a baffle is installed, upon impact of which the liquid flow occurs, cavitation occurs, air enters the inner zone of the liquid flow plume through the channel in the baffle and through the hole in it.
